(19) United States
(12) Patent Application Publication
(10) Pub. No.: US 2009/0031910 A1
(43) Pub. Date: Feb. 5, 2009

(54) Mechanical Device for Removably Fixing a Sleeve to a Support Shaft of a Printing Machine

(76) Inventor: Pierre Simon, Orleans (FR)

Correspondence Address: YOUNG & THOMPSON, 209 Madison Street, Suite 500, ALEXANDRIA, VA, 22314, US

(21) Appl. No.: 11/919,520

(22) PCT Filed: Apr. 28, 2006
(86) PCT No.: PCT/FR2006/000972

§ 371 Date: Apr. 1, 2008

(30) Foreign Application Priority Data
Apr. 28, 2005 (FR) 0504322

(51) Int. Cl. B41F 27/10

(52) U.S. Cl. 101/479

(57) ABSTRACT

A device for removably fixing a sleeve (5) to a cylindrical support shaft (3) of a printing machine. The inventive device is characterised in that: the inner face (5b) of the sleeve (5) includes at least one cylindrical stiffened area (24); and the support shaft/sleeve assembly is equipped with (i) elements which, in the operating position and under the action of members that supply a clamping force (21, 32, 32′), apply at least one pressing member (15, 30, 40) against the stiffened area (24) in order to render same solidly connected to the sleeve (5), and (ii) elements which, in the mounting/disassembly position and under the action of members that supply a releasing force, release the pressing member (15, 30, 40).

This present invention concerns a device for the fitting of a sleeve onto a shaft of a printing machine, and in particular an offset printing machine, a heliogravure machine, or a flexographic printing machine.

It is known that, in some cases, the printing cylinders of printing machines can be composed of a removable sleeve that is fixed to a support shaft. Such an arrangement has many advantages and in particular that of allowing the user to vary the printing format to his taste by a simple exchange of the sleeve.

In order to affect the fitting of the sleeve onto the support cylinder, it has been proposed that use should be made of the deformation of the sleeve under the effect of a pressurised-air circuit for example, or on the effect of the support shaft by expansion of the latter during use under the effect of oil pressure. It has also been proposed, in patent FR-B-2.742.379, that one should place a deformable duct between the sleeve and the support shaft, and that the surface of the shaft should be hollowed out into a series of cavities, separated from each other by retention surfaces on which the duct is resting, with the latter being designed to deform so that it is capable of having two positions, namely an assembly position in which each part of its surface that is located facing a cavity deforms into the latter under the action of a constraint, and a rest position in which the deformable zone has recovered its initial shape at least in part, so that it can be applied against the internal surface of the sleeve.

Although using an extractable sleeve has undeniable advantages in relation to the production costs and the simplicity of manufacture of the printing cylinders, it also has drawbacks in the sense that, in principle, it necessitates providing certain parts with a measure of flexibility, and this flexibility then gives rise to a certain imprecision in rotation during use.

The aim of this present invention is to propose an inexpensive device that can be used to fit a sleeve to a support shaft in a removable manner, which is sufficiently powerful to allow printing of the offset or helio type, and which employs a totally mechanical fitting method that will guarantee correct retention of the sleeve on its support shaft.

The subject of this present invention is therefore a device for the mechanical fitting of a sleeve onto a cylindrical support shaft of a printing machine, characterised in that

the inner face of the sleeve has at least one stiffened cylindrical zone,

the support-shaft/sleeve assembly is equipped firstly with means that, in the working position, under the action of means that provide a tightening force, are designed to apply at least one pressure element against the stiffened zone, in order to ensure its attachment to the sleeve, and secondly, with means that, in the fitting/removal position, under the action of means that provide a loosening force, are designed to release the pressure element.

In a manner that allows the use of sleeves that are made from light materials, such as aluminium or synthetic materials for example, the stiffened zone can be composed of a ring, in particular of metal, and especially such as a bearing ring, on the inner face of which the pressure element will be applied in the working position so as to ensure the locking of the support shaft to the sleeve. The means that provide a tightening and/or loosening force can be internal means included in the support-shaft/sleeve assembly, or external means, and can then in particular be of the hydraulic or pneumatic type.

The means that provide a tightening and/or loosening force can be composed of energy storage means such as, for example, at least one elastic element that is in the compressed state when it is in the working position, and in particular a spring or a sprung ring.

According to the invention, the pressure element can be composed of a block formed from at least one assembly washer for example.

In one embodiment of the invention, the support shaft will be hollowed out with a central and longitudinal housing inside which a control shaft will be mounted to slide. This control shaft can be traversed by at least one radial element providing a link in translation with a ring mounted to slide on the support shaft, and that will be designed to longitudinally compress the pressure element when the user moves the control shaft in the direction of the latter, under the action of means that provide a tightening force.

Preferably, in the working position, the sleeve will be resting against a shoulder of the support shaft, so as to ensure the indexing in translation of these two elements. In addition, their indexing in rotation will be provided by a link element such as a cotter pin or a key for example.

In another embodiment, the control shaft can include a tapered part, and the wall of the support shaft will be traversed by at least one radial housing in which a ball will be placed, so that a longitudinal displacement of the control shaft in one direction applies this ball against the sleeve so as to attach the latter to the support shaft and so that a longitudinal displacement of the control shaft in the other direction does not apply this ball against the sleeve so as to detach the latter from the support shaft.

By way of a non-limiting example, a description will now be given of one form of implementation of this present invention, with reference to the appended drawing, in which:

FIG. 1 is a view in longitudinal section of a print cylinder according to the invention, shown in the fitting/removal position of the sleeve,

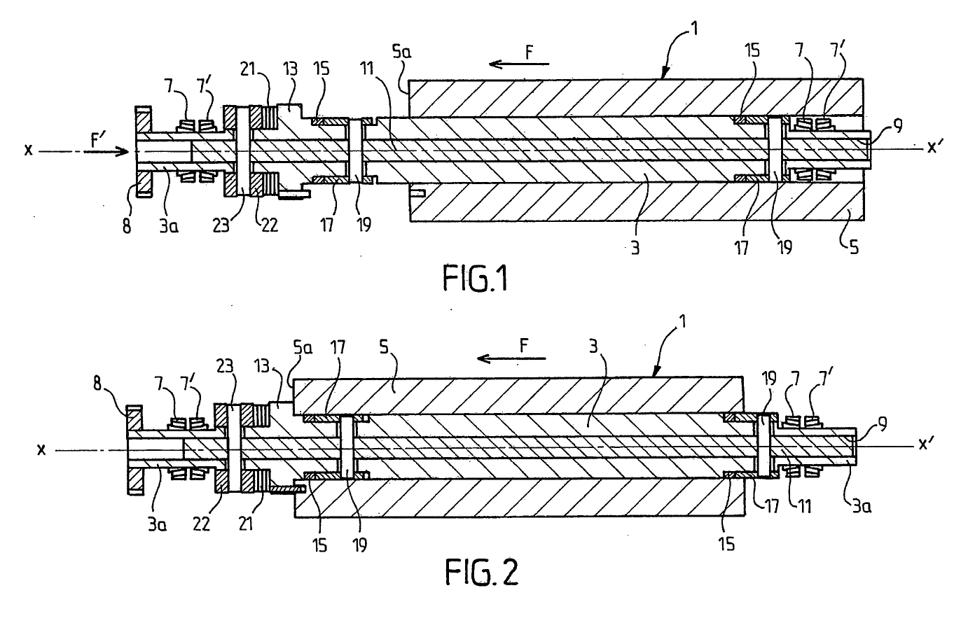

FIG. 2 is a view in longitudinal section of the print cylinder shown in FIG. 1 in the working position,

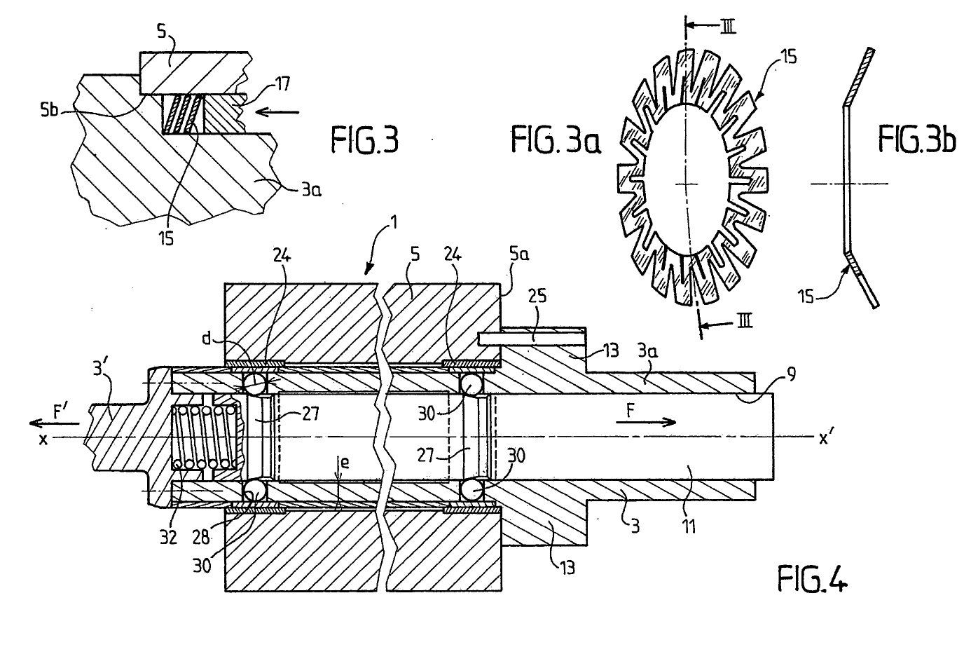

FIG. 3 is a partial view in enlarged section showing a detail of the implementation of means for clamping the sleeve onto the support shaft,

FIG. 3a is a view in perspective of an assembly washer used in the clamping blocks implemented according to the invention,

FIG. 3b is a view in diametrical section, along line III-III of FIG. 3a), of the assembly washer shown in the latter,

FIG. 4 is a view in longitudinal section of a second embodiment of a print cylinder according to the invention, shown in the working position,

FIG. 5 is a view in longitudinal section of a third embodiment of a print cylinder according to the invention, shown in the working position,

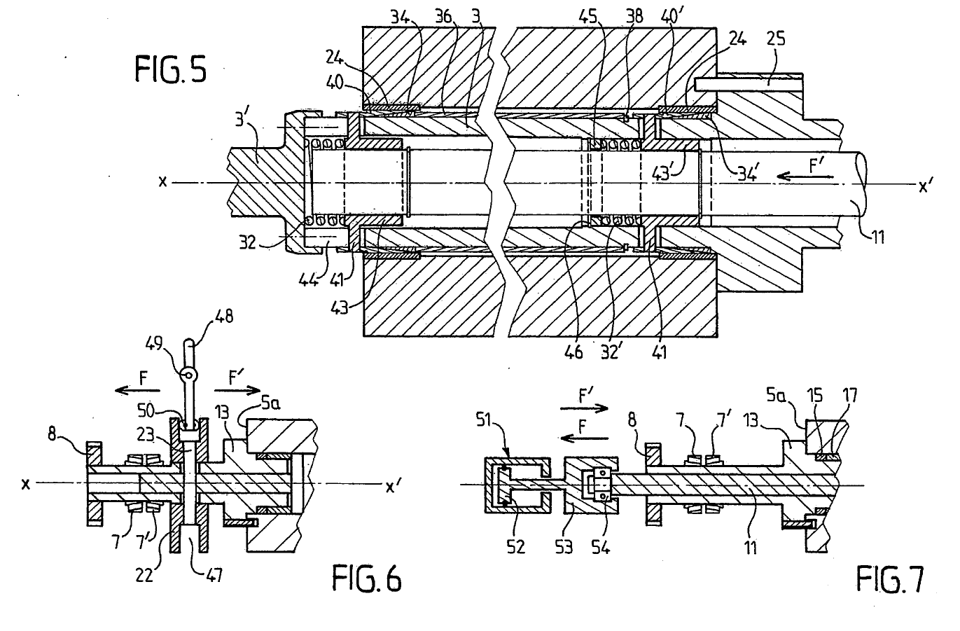

FIG. 6 is a view in partial longitudinal section of a fourth embodiment of a print cylinder according to the invention, shown in the working position,

FIG. 7 is a view in partial longitudinal section of another embodiment of a print cylinder according to the invention, shown in the working position.

FIGS. 1 to 3 show a print cylinder 1 that can, for example, depending on its use, be a plate-bearing cylinder, a blanket-bearing cylinder as used in offset printing, a die-bearing cylinder as in the case of flexogravure printing, or an etched cylinder in the case of heliographic printing.

This print cylinder 1 is essentially composed of a support shaft 3 on which a sleeve 5 is fitted in a removable manner. In the embodiment shown in the figures, the sleeve 5 is composed of very thick tubular steel element that is threaded onto the support shaft 3, so that its stiffened zone extends over all of its length.

The support shaft is composed of a cylindrical element that is terminated at each end by a smaller diameter portion 3a on which two bearings 7, 7′ are placed, with the left part in the figure having a drive pin 8. The support shaft 3 is pierced, over all of its length, with a central, longitudinal housing 9, inside a control shaft 11, which is mounted to slide. On one of its sides, on the left in FIGS. 1 and 2, the support shaft 3 is equipped with a cylindrical shoulder 13 against which, in the working position, one of the transverse faces 5a of the sleeve 5 is held in contact.

In the embodiment shown in FIGS. 1 to 3, the retention of the sleeve 5 on the support shaft 3 is effected by a clamping action that is applied at the two extremities of the support shaft. To this end, use is made of assembly washers 15, in particular of the type shown in FIGS. 3a and 3b which, as shown in FIG. 3, are placed on the smaller diameter portion 3a of the support shaft 3 and that, when they are in the unclamped position (FIG. 3) are inclined in relation to the diametrical plane of the shaft, and are in contact with the inner face 5b of the sleeve 5. Force transmission rings 17 are mounted to slide between portion 3a of the support shaft 3 and the sleeve 5, so that when the latter are placed in the direction of arrow F, the rings 15 are deformed, which are then braced to press strongly against the inner face 5b of the sleeve 5 thus performing a clamping action of the latter onto the support shaft 3.

The displacement of the transmission rings 17 is performed by transverse cotter pins 19 that pass through the rings 17, the support shaft 3 and the control shaft 11. The cotter pins 19 are adjusted in the control shaft 11, and some play has been arranged between the said cotter pins 19 and the transverse orifices created in the support shaft 3, so that when the control shaft 11 is moved longitudinally in its housing 9 within the support shaft 3, the transmission rings 17 are displaced so as to ensure either compression of the assembly washers 15, when it is desired to execute the clamping action of the sleeve 5 onto the support shaft 3, or the unclamping of these washers 15, when it is desired to execute the release of the sleeve 5 in relation to the support shaft 3.

The energy necessary for application of the transmission rings 17 onto the assembly washers 15 is supplied by elastic compression washers 21 that are placed between the shoulder 13 and a cylindrical ring 22 threaded onto the portion 3a of the support shaft 3, with this ring 22 being immobilised in translation by a transverse cotter pin 23 passing through the latter and the control support shafts 3, 11. The positioning of the ring 22 in relation to the shoulder 13 is such that the said ring 22 performs an elastic compression of the compression washers 21, so that the energy stored by the latter during this compression is greater than the force that the transmission rings 17 must transmit in order to perform the squeezing of the assembly washers 15.

Thus, in the working position that is represented in FIG. 2, the elastic compression washers 21 push the ring 22 to the left of the drawing, which therefore, by means of the transverse cotter pin 23, drives the control shaft 11 in the direction of arrow F, so that the latter in its turn drives the transverse cotter pins 19 in this same direction, with the effect of causing the displacement of the transmission rings 17 and performing the squeezing of the assembly washers 15, thus resulting in the clamping action of the sleeve 5 onto the support shaft 3.

When the user wishes to remove the sleeve 5, he then only has to exert a force in direction F′ onto the control shaft 11, which has the effect, by displacement of the latter, of compressing the elastic compression washers 21 and, by means of the transverse cotter pins 19 engaged with the rings 17, releasing the assembly washer blocks (clamping blocks) 15 which in turn releases the sleeve 5 from the support shaft 3 and so allows its removal.

It is possible of course, according to the invention, to make use of any number of clamping blocks distributed over the length of the support shaft 3 and the sleeve 5. It is also possible, according to the invention, to have only a single clamping block at the centre of these two elements, and to constitute a clamping block that extends over all of the common length of the sleeve and the shaft.

Again according to the invention, it is possible to make use of other means for the application and maintenance of pressure, and in particular, as shown in FIG. 4, of means that make use of truncated cones and balls.

In such an embodiment of the invention, the print cylinder 1 is composed of a support shaft 3 and of a sleeve 5 that is fitted on so that it slides on the latter. This sleeve is hollowed out at both ends with a cylindrical housing in which a stiffening ring is located, which in this case is bearing ring 24, so that the sleeve 5 is in contact with the support shaft 3 at the internal surface of the latter. In its working position, one of the transverse faces 5a) of the sleeve 5 bears against a cylindrical shoulder 13 of the control shaft 11 and this ensures its registration in the longitudinal direction, and a cotter pin 25 passes through the shoulder 13 to slot into a housing in the sleeve 5 in order to ensure the registration of these two elements in rotation.

The support shaft 3 is traversed by a central and longitudinal housing 9 in which a control shaft 11 is mounted to slide, with the latter having a tapered part 27 opposite to the bearing rings 24.

The wall of the support shaft 3 is pierced by several radial housings 28 that accommodate balls 30 with a diameter (d) that is greater than the thickness (e) of the said wall. The diameter (d) is such that when pressure is applied to the control shaft 11 in the direction of arrow F, the respective tapered parts 27 push the balls 30 toward the exterior, and apply the latter against the inner face of the bearing rings 24 with the effect of locking the sleeve 5 onto the support shaft 3, and when no force is applied to the control shaft 11, these elements are free to slide.

In the embodiment shown in FIG. 4, the energy necessary for the attachment of the sleeve 5 and the shaft 3 is supplied by a compression spring 32 that is placed between two small troughs, one formed by a housing hollowed out in the end of the control shaft 11, and the other in a extension element 3′) of the support shaft 3 which is fixed at the end of the latter by fixing means that are not shown on the drawing. It is arranged, of course that the stiffness of the compression spring 32 is such that, in its compressed state, which occurs when the print cylinder 1 is in the working position, the energy that it delivers is sufficient so that the clamping force applied by the balls 30 on the sleeve 5 results in the correct driving of the latter.

When the user wishes to remove the sleeve 5, he applies a force F′ onto the control shaft 11 that is opposite to that applied by the compression spring 32, so that the balls 30 are no longer pressed against the sleeve 5.

It is possible of course, according to the invention, to make use of other means that apply a radial force from the support shaft 3 onto the inner face of the sleeve 5, and in particular onto the inner face of the stiffening rings with which the latter may be equipped.

It is therefore possible to make use of any means that will in particular allow the conversion of force in a longitudinal direction along axis xx′ of the print cylinder 1 into a force in a radial direction. It is therefore possible, as shown in FIG. 5, to replace the tapered parts 27, and the balls 30 associated with them, by two tapered rings. More precisely, a first tapered ring 34, with the taper oriented to the exterior, is placed at one end of the support shaft 3, this tapered ring being locked against any displacement in translation by a sleeve 36 which itself is immobilised by a circlip 38. A second tapered ring 40 whose taper is reversed in relation to the first, will be placed to mate with the latter, so that all longitudinal displacement toward the interior of the second tapered ring 40 results in a radial displacement of the latter, and the application of its outer surface against the inner surface of the bearing ring 24. As in the previous embodiment, the necessary energy will be supplied by a compression spring 32 that is inserted between a shoulder 41 of a ring 43 placed between the control shaft 11 and the internal surface of the support shaft 3 and an extension element 3′ of the latter fixed onto the support shaft 3 by spacers 44 and fixing means not shown on the drawing.

Where necessary, the other extremity of the print cylinder 1 can also be fitted with means for clamping the sleeve 5 onto the support shaft 3. To this end, it can therefore include means of the same type, namely a set complementary conical rings as well as its own system for the storage and distribution of energy, composed of a compression spring 32′ placed between an inner ring 45 immobilised in translation by a circlip 46 and a ring 43′ of the same type as the first, and that is thus equipped with a shoulder 41 that rests against the second tapered ring.

In these conditions, it can be seen that, in the working position, as shown in FIG. 5, the spring 32′ presses onto the circlip 46 and by means of the ring 43′, applies the second tapered ring 40′ against the first tapered ring 34′ which has the effect of applying it against the inner face of the bearing ring 24, thus effecting the locking of the support shaft 3 and the sleeve 5. Likewise, in this position, the spring 32 presses onto the extension element 3′ and, by means of the ring 43, applies the second tapered ring 40 against the first tapered ring 34, which has the effect of applying it against the inner face of the bearing ring 24. To remove the sleeve 5, then as before, the user only has to apply a force in direction F′ onto the control shaft 11.

According to the invention, the force necessary for the application of the pressure element onto the stiffened zone of the sleeve can be produced by elements exterior to the support-shaft/sleeve assembly.

Thus in the embodiment shown in FIG. 6, the elastic compression washers 21 of FIGS. 1 and 2 have been eliminated, and a circular groove 47 has been machined in the ring 22. An external control lever 48 has also been provided, mounted to pivot about an axis 49 that terminates in the groove 47 by a feeler 50, by means of which longitudinal forces with a resultant in direction F in the working position and in direction F′ in the fitting/removal position, are applied respectively onto the ring 22. It is also possible to make use of pneumatic or hydraulic means, as shown in FIG. 7, to control application of the pressure element onto the stiffened zone of the sleeve 5.

In this figure, use is made of hydraulic means, which are represented schematically. The necessary energy is supplied by a hydraulic actuator 51, the piston 52 of which has a cage 53 at its active end that is used to hold a bearing 54 whose internal part is attached to the end of the control shaft 11. It can be seen that, in the working position (FIG. 7), the actuator applies a force F onto the control device 11, which has the effect, by means of the cotter pins 19, of applying the transmission rings 17 onto the assembly washers 15 constituting the pressure element.

Naturally in the fitting/removal position, a force F′ is applied with the actuator 51 in an opposite direction, with the effect of separating the transmission rings 17 from the assembly washers 15, so that they are no longer compressed, thus freeing the sleeve from its support shaft 3.

It is possible of course, without moving outside of the protective scope of this present invention, to make use of any other means designed to communicate a tightening/loosening force to the pressure element.

1. A device for the mechanical fitting of a sleeve (5) onto a cylindrical support shaft (3) of a printing machine, characterised in that:
the inner face (5b) of the sleeve (5) has at least one stiffened cylindrical zone (24),
the support-shaft/sleeve assembly is equipped firstly with means that, in the working position, under the action of means that provide a tightening force (21, 32, 32′) are designed to apply at least one pressure element (15, 30, 40) against the stiffened zone (24), in order to ensure its attachment to the sleeve (5), and secondly, with means that, in the fitting/removal position, under the action of means that provide a loosening force, are designed to release the pressure element (15, 30, 40).

2. The device according to claim 1, characterised in that the stiffened zone is composed of a ring, in particular of metal, such as in particular a bearing ring (24), onto the inner face of which the pressure element (15, 30, 40) is applied in the working position.

3. The device according to claim 1, characterised in that the means that provide a tightening and/or loosening force are internal means which are included in the support-shaft/sleeve assembly.

4. The device according to claim 1, characterised in that the means that provide a tightening and/or loosening force are of the hydraulic or pneumatic type external to the support-shaft/sleeve assembly.

5. The device according to claim 1, characterised in that the means that provide a tightening and/or loosening force are composed of energy storage means.

6. The device according to claim 5, characterised in that the energy storage means are composed of at least one elastic element (21,32) that is in the compressed state when it is in the working position.

7. The device according to claim 6, characterised in that the elastic element is composed of at least one spring (32, 32′) or of at least one sprung ring (21).

8. The device according to claim 1, characterised in that the pressure element is composed of a block formed from at least one assembly washer (15).

9. The device according to claim 1, characterised in that the support shaft (3) is hollowed out with a central and longitudinal housing (9) on the inside of which a control shaft (11) is mounted to slide.

10. The device according to claim 9, characterised in that the control shaft (11) is traversed by at least one radial element (19) which locks it in translation with a ring (17) mounted to slide on the support shaft (3), and that is designed to longitudinally compress the pressure element (15) when the control shaft (11) is moved in the direction of the latter under the action of means that provide a tightening force (21).

11. The device according to claim 1, characterised in that, in the working position, the sleeve (5) is pressed against a shoulder (13) of the support shaft (3) so as to ensure the registration in translation of these two elements.

12. The device according to claim 1, characterised in that, in the working position, the sleeve (5) and the support shaft (3) are joined together by a link element, such as a cotter pin (25) or a key, in particular, so as to effect their registration in rotation.

13. The device according to claim 9, characterised in that, the control shaft (11) has a tapered part (27) opposite to each stiffened zone, and the wall of the said support shaft (3) is traversed by at least one radial housing (28) in which a ball (30) is placed so that a longitudinal displacement of the control shaft (11) in one direction applies this ball (30) against the sleeve (5) so as to attach the latter to the support shaft (3), and that a longitudinal displacement of the control shaft (11) in the other direction does not apply this ball (30) against the sleeve (5) so as to detach the latter from the support shaft (3).

14. The device according to claim 2, characterised in that the means that provide a tightening and/or loosening force are internal means which are included in the support-shaft/sleeve assembly.

15. The device according to claim 2, characterised in that the means that provide a tightening and/or loosening force are of the hydraulic or pneumatic type external to the support-shaft/sleeve assembly.

16. The device according to claim 2, characterised in that the means that provide a tightening and/or loosening force are composed of energy storage means.

17. The device according to claim 2, characterised in that the pressure element is composed of a block formed from at least one assembly washer (15).

18. The device according to claim 2, characterised in that the support shaft (3) is hollowed out with a central and longitudinal housing (9) on the inside of which a control shaft (11) is mounted to slide.

19. The device according to claim 2, characterised in that, in the working position, the sleeve (5) is pressed against a shoulder (13) of the support shaft (3) so as to ensure the registration in translation of these two elements.

20. The device according to claim 2, characterised in that, in the working position, the sleeve (5) and the support shaft (3) are joined together by a link element, such as a cotter pin (25) or a key, in particular, so as to effect their registration in rotation.
